(19) United States
(12) Patent Application Publication
(10) Pub. No.: US 2023/0002079 A1
(43) Pub. Date: Jan. 5, 2023

(54) SEAPLANE TOWING DEVICE

(71) Applicant: William Oliver Young, Spartanburg, SC (US)

(72) Inventor: William Oliver Young, Spartanburg, SC (US)

(21) Appl. No.: 17/363,398

(22) Filed: Jun. 30, 2021

(51) Int. Cl. B64F 1/22

(52) U.S. Cl. CPC B64F 1/221; B64F 1/224; B64C 25/34

(57) ABSTRACT

An airplane towing system includes telescoping actuators on tow rods that react to pushing, towing, and turning forces to distribute the forces to the tow rods rather than to an airplane structure.

### BACKGROUND OF THE DISCLOSURE

Seaplanes with pontoons for landing on water are well known. Seaplanes also include conventional landing gear built into or adjacent the pontoons for landing on runways and to maneuver the seaplanes on land. Like standard aircraft, seaplanes are often parked on tarmacs or in hangars for storage or maintenance. Also like standard aircraft, seaplanes sometimes are moved to different locations within hangars or on tarmacs using tow tractors. Typically, a towing apparatus is connected to the landing gear of a seaplane and to a tow tractor. The towing apparatus is usually rigid to maintain a safe distance between the seaplane and the tow tractor since a chain or rope cannot be used to push the seaplane, nor stop its forward momentum, and can snap or break under a repeated or constant pulling force. At least one problem with the conventional towing apparatus and arrangement is that the apparatus is attached directly to the landing gear of the seaplane. This can exert undue towing and pushing forces on the relatively fragile landing gear.

What is needed in the aviation industry is a towing system that will not place unnecessary stress on landing gear, particularly those of a seaplane.

### BRIEF SUMMARY OF THE DISCLOSURE

The present disclosure is directed in general to towing systems that attach to cross beams or other structural members of seaplanes, other than landing gear, for towing, pushing, and maneuvering seaplanes on land using a tow tractor. The towing systems are simple to make, easy to use, enhance aviation safety, and safeguard landing gear integrity.

In an exemplary embodiment, an airplane towing system may include a first telescoping bar having a proximal end and a distal end. The distal end is rotatably connected to a tow hitch, and the first telescoping bar can compress or extend in response to an external force, such as a towing, turning, or pulling force. A first actuator is located between the proximal and distal ends of the first telescoping bar, and the first actuator can compress or extend the first telescoping bar in response to the external force. Similarly, a second telescoping bar may be provided with a proximal end and a distal end. The distal end of the second telescoping bar can be rotatably connected to the tow hitch, and the second telescoping bar can compress or extend in response to the external force. Further, a second actuator may be installed between the proximal and distal ends of the second telescoping bar. The second actuator can compress or extend the second telescoping bar in response to the external force. Also, a first clamping assembly may be rotatably connected to the proximal end of the first telescoping bar, and a second clamping assembly may be rotatably connected to the proximal end of the second telescoping bar. The first and second clamping assemblies can be to an airplane.

In this exemplary embodiment, the first telescoping bar may further include a proximal rod and a distal rod in which the proximal rod is movable within the first actuator. Likewise, the second telescoping bar may further include a proximal rod and a distal rod in which the proximal rod is movable within the second actuator.

The first actuator in this embodiment also may include a raceway and a pin that can be inserted through the first telescoping bar and through the raceway. The pin and the raceway operate to delimit travel of the first telescoping bar. Similarly, the second actuator of the embodiment may include a raceway and a pin being that can be inserted through the second telescoping bar and through the raceway whereby the pin and the raceway cooperate to delimit travel of the second telescoping bar.

Also in this embodiment, the first and second actuators can cooperate to extend or compress respective first and second telescoping bars in response to the external force, wherein again the external force may be a towing force, a pushing force, a turning force, or combinations of these forces.

The exemplary embodiment may further include a protective material placed between the first and second clamping assemblies and a cross beam of the airplane. The protective material may be neoprene or other cushioning material and can be affixed to interiors or undersides of the first and second clamping assemblies or wrapped over the cross beam before attaching the first and second clamping assemblies.

The airplane towing system may also include a cross bar connected to the proximal end of the first telescoping bar and the proximal end of the second telescoping bar with the first and second clamping assemblies being attached to the bar.

In another exemplary embodiment, an airplane towing system may include a first telescoping bar having a proximal end and a distal end, the distal end being configured for rotatable connection to a tow hitch, the proximal end being configured to compress or extend relative to the distal end in response to an external force; a second telescoping bar having a proximal end and a distal end, the distal end of the second telescoping bar being configured for rotatable connection to the tow hitch, the proximal end of the second telescoping bar being configured to compress or extend relative to the distal end of the second telescoping bar in response to an external force; a first clamping assembly rotatably connected to the proximal end of the first telescoping bar; and a second clamping assembly rotatably connected to the proximal end of the second telescoping bar, the first and second clamping assemblies being attachable to an airplane.

The airplane towing system in this embodiment may further include a protective material for placement between the first and second clamping assemblies and a cross beam of the airplane. Still further, a cross bar may be connected to the proximal end of the first telescoping bar and to the proximal end of the second telescoping bar.

In yet another exemplary embodiment, an airplane towing system may include a first bar having a proximal end and a distal end, the distal end being configured for rotatable connection to a tow hitch; a second bar having a proximal end and a distal end, the distal end of the second bar being configured for rotatable connection to the tow hitch; a first clamping assembly rotatably connected to the proximal end of the first telescoping bar; a second clamping assembly rotatably connected to the proximal end of the second bar; and a protective material configured for placement between the first and second clamping assemblies and a cross beam of the airplane, the first and second clamping assemblies being attachable the cross-beam airplane. The airplane towing system may also include a cross bar connected to the proximal end of the first bar and the proximal end of the second bar.

Additional objects and advantages of the present subject matter are set forth in, or will be apparent to, those of ordinary skill in the art from the description herein. Also, it should be further appreciated that modifications and variations to the specifically illustrated, referenced, and discussed features, processes, and elements hereof may be practiced in various embodiments and uses of the disclosure without departing from the spirit and scope of the subject matter. Variations may include, but are not limited to, substitution of equivalent means, features, or steps for those illustrated, referenced, or discussed, and the functional, operational, or positional reversal of various parts, features, steps, or the like. Those of ordinary skill in the art will better appreciate the features and aspects of the various embodiments, and others, upon review of the remainder of the specification.

### BRIEF DESCRIPTION OF THE DRAWINGS

A full and enabling disclosure of the present subject matter, including the best mode thereof directed to one of ordinary skill in the art, is set forth in the specification, which refers to the appended figures, wherein:

FIG. 1 is a partial, side, elevational view of an embodiment of a towing system in an intended use environment according to an aspect of the disclosure;

FIG. 2 is top plan view of the embodiment of FIG. 1, particularly showing the towing system in a first forward state and a second turning state (in phantom for clarity);

FIG. 3 is a partial perspective view of the embodiment as in FIG. 1;

FIG. 4 is a plan view of the towing system as used in FIG. 1, particularly showing the embodiment in the first forward state;

FIG. 5 is a partial, sectional side view taken along lines V-V in FIG. 4;

FIG. 6 is a plan view of the towing system as in FIG. 4, particularly showing the embodiment in the second turning state;

FIG. 7 is a partial, sectional side view taken along lines VII-VII in FIG. 6;

FIG. 8 is a partial perspective view of another embodiment of a towing system in an intended use environment according to an aspect of the disclosure;

FIG. 9 is a plan view of the towing system as used in FIG. 8, particularly showing the embodiment in the first forward state; and

FIG. 10 is a partial perspective view of another embodiment of a towing system in an intended use environment according to an aspect of the disclosure.

### DETAILED DESCRIPTION OF THE DISCLOSURE

As required, detailed embodiments are disclosed herein; however, the disclosed embodiments are merely exemplary and may be embodied in various forms. Therefore, specific structural and functional details disclosed herein are not to be interpreted as limiting, but merely as a basis for the claims and as a representative basis for teaching one skilled in the art to variously employ the exemplary embodiments of the present disclosure, as well as their equivalents.

Unless defined otherwise, all technical and scientific terms used herein have the same meaning as is commonly understood by one of ordinary skill in the art to which this disclosure belongs. In the event that there is a plurality of definitions for a term or acronym herein, those in this section prevail unless stated otherwise.

Wherever the phrase “for example,” “such as,” “including,” and the like are used herein, the phrase “and without limitation” is understood to follow unless explicitly stated otherwise. Similarly, “an example,” “exemplary,” and the like are understood to be non-limiting.

The term “substantially” allows for deviations from the descriptor that do not negatively impact the intended purpose. Descriptive terms are understood to be modified by the term “substantially” even if the word “substantially” is not explicitly recited.

The term “about” when used in connection with a numerical value refers to the actual given value, and to the approximation to such given value that would reasonably be inferred by one of ordinary skill in the art, including approximations due to the experimental and or measurement conditions for such given value.

The terms “comprising” and “including” and “having” and “involving” (and similarly, “comprises,” “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etcetera. Thus, for example, “a device having components a, b, and c” means that the device includes at least components a, b, and c. Similarly, the phrase “a method having a, b, and c” means that the method includes at least steps a, b, and c.

Where a list of alternative component terms is used, e.g., “a structure such as ‘a’, ‘c’, ‘d’ or the like,” or “a or b,” such lists and alternative terms provide meaning and context for the sake of illustration, unless indicated otherwise. Alternative terms also may be presented in this order “‘a’, ‘b’, or ‘c’” followed by an element number. Also, relative terms such as “first,” “second,” “third,” “front,” and “rear” are intended to identify or distinguish one component or feature from another similar component or feature, unless indicated otherwise herein.

Unless the context clearly requires otherwise, throughout the description and the claims, the words “comprise,” “comprising,” and the like are to be construed in an inclusive sense as opposed to an exclusive or exhaustive sense; in the sense of “including, but not limited to.”

The various embodiments of the disclosure and/or equivalents falling within the scope of present disclosure overcome or ameliorate at least one of the disadvantages of the prior art or provide a useful alternative.

Detailed reference will now be made to the drawings in which examples embodying the present subject matter are shown. The detailed description uses numerical and letter designations to refer to features of the drawings. The drawings and detailed description provide a full and written description of the present subject matter, and of the manner and process of making and using various exemplary embodiments, so as to enable one skilled in the pertinent art to make and use them, as well as the best mode of carrying out the exemplary embodiments. The drawings are not necessarily to scale, and some features may be exaggerated to show details of particular components. Thus, the examples set forth in the drawings and detailed descriptions are provided by way of explanation only and are not meant as limitations of the disclosure. The present subject matter thus includes any modifications and variations of the following examples as come within the scope of the appended claims and their equivalents.

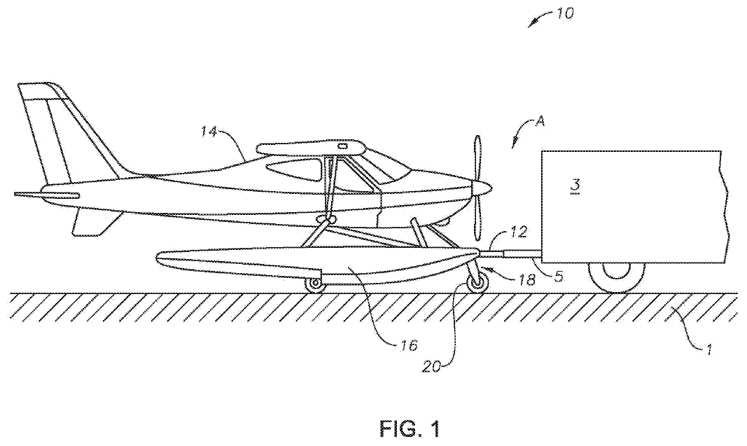

Turning now to FIG. 1, an airplane towing system according to one aspect of the disclosure is designated broadly by element number 10. Here, the exemplary towing system 10 is shown in a first state or equilibratory position A in which a towing apparatus 12 is being used to push or pull a seaplane 14 in a straight line along a tarmac or hangar floor 1 by ground support equipment, such as a tug or tow tractor 3. In this example, the towing apparatus 12 is connected to a tow bar or hitch 5 of the tractor 3 and to the seaplane 14 between its pontoons 16, rather than connecting the towing apparatus 12 to landing gear 18 and tires 20 of the seaplane 14.

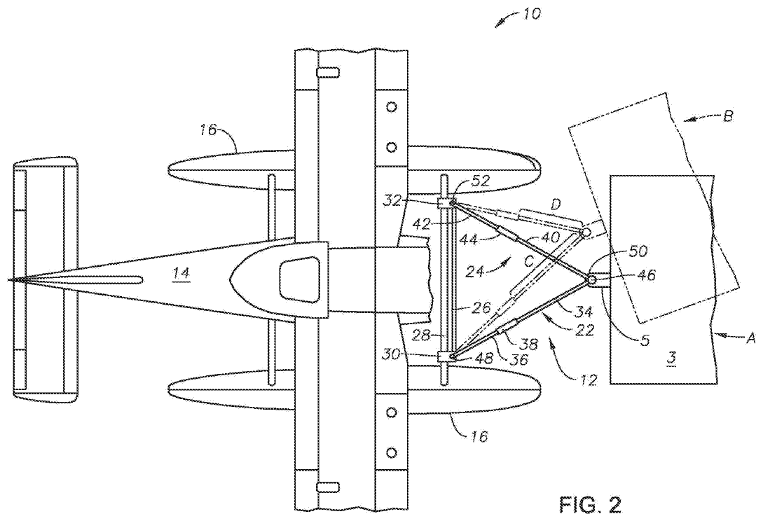

FIG. 2 shows that the towing apparatus 12 may include a first variable length or responsive bar 22, a second variable length or responsive 24, and a fixed bar 26. The towing apparatus 12 can be connected to a structural beam, cross bar, or spreader bar 28 of the seaplane 14 using cuffs or clamping devices or assemblies 30, 32, which are discussed in further detail below. Here, the responsive bar 22 may include a first arm or rod 34, a second arm or rod 36, and an actuation device or telescoping actuator 38. Likewise, the responsive bar 24 may include a first arm or rod 40, a second arm or rod 42, and an actuating device or telescoping actuator 44. More particularly, the responsive bar 22 may be rotationally connected at a first or distal end 46 to the hitch 5 of the tractor 3 and rotationally connected at a proximal or opposite end 48 to the clamping device 30. Similarly, the responsive bar 24 may be rotationally connected at a first distal end 50 to the hitch 5 of the tractor 3 and rotationally connected at an opposite, proximal end 52 to the clamping device 32.

As FIG. 2 further shows, when the seaplane 14 is being pushed or pulled in a straight-line by exemplary towing system 10 in the first state A, the towing apparatus 12 is in equilibrium and the responsive bars 22, 24 appear symmetrical. By way of comparison, if the tractor 3 turns to the left as shown in this example (in phantom for clarity), the actuator 38 permits the responsive bar 22 to extend or telescope as shown in phantom state C while the actuator 44 permits the responsive bar 24 to compress as shown in phantom state D to reduce twisting and torsional forces on the seaplane 14. The fixed bar 26 ensures that the proximal ends 48, 52 remain spaced apart as shown and that rotational forces are applied to the distal ends 46, 50. The respective extension and compression of the responsive bars 22, 24 would, of course, be reversed if the tractor 3 turns to the right, as further explained below.

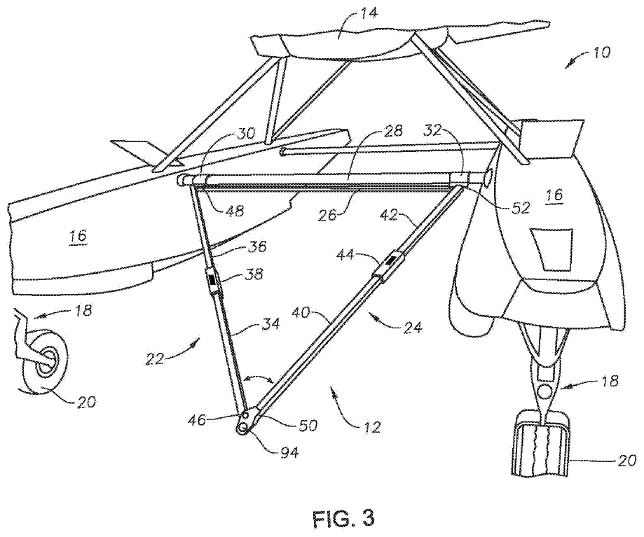

FIG. 3 broadly shows the towing apparatus 12 and its responsive bar 22, the second responsive bar 24, and the fixed bar 26 of the towing system 10. As introduced above, the towing apparatus 12 in this example is shown connected to the spreader bar 28 of the seaplane 14 using the clamping devices 30, 32. Also as introduced above, the responsive bar 22 in this example includes the rod 34, the rod 36, and the actuation device 38. The responsive bar 24 includes rods 40, 42, and the actuating device 44. Again, the responsive bar 22 may be rotationally formed at one end 46 and rotationally connected at the opposite end 48 to the clamping device 30. And the responsive bar 24 may be rotationally connected at one end 50 and rotationally connected at the opposite end 52 to the clamping device 32. As introduced, this arrangement applies towing and other forces to the towing apparatus 12 rather the landing gear 18. More particularly, a scissor-like attachment assembly 94, which may include an aperture or ring, is provided for connecting the ends 46, 50 to the tractor 3 as shown in FIG. 2. In operation, as the plane 14 and the towing apparatus 12 are turned, the scissor-like attachment assembly 94 will permit the bars 22, 24 to scissor together or towards each other, as indicated by the double-headed arrow between the bars 22, 24. The attachment mechanism 94 is not limited to the example shown and may include a hook, a chain, a cap, and the like.

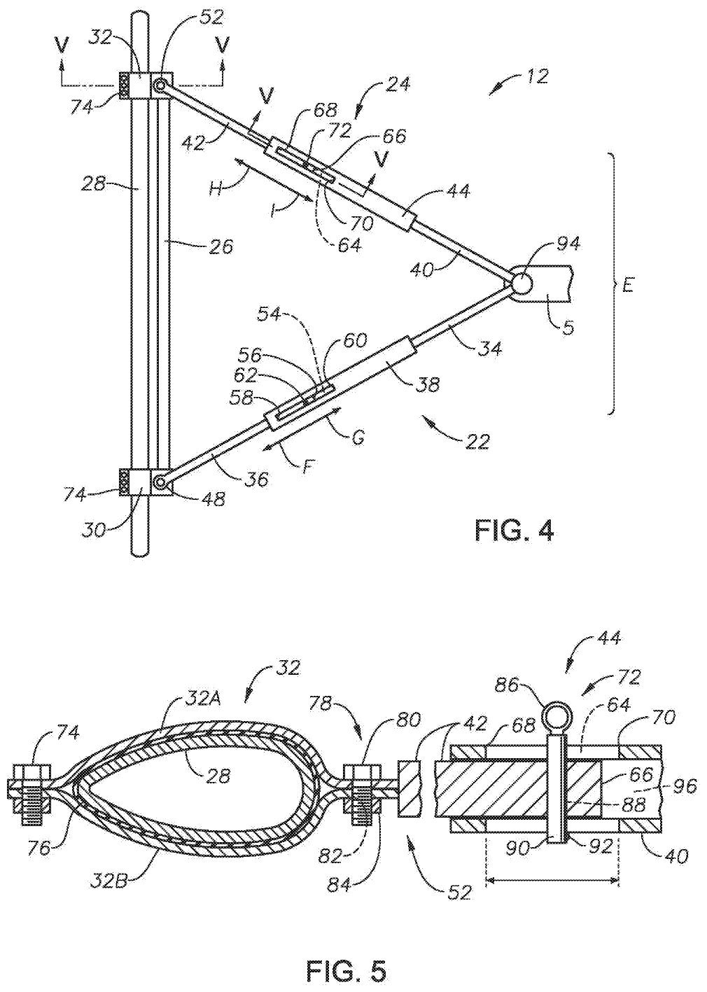

FIG. 4 more specifically shows the towing apparatus 12 and its bars 22, 24, and 26, respective rods 34, 36, 40, 42, and actuation devices 38, 44 in a neutral position E, as introduced in FIG. 3. The clamping devices 30, 32 may include attachment devices 74 such as bolts, screws, Cotter keys or the like to connect the towing apparatus 12 to the cross bar 28 as described above. More particularly, a window, raceway, or slot 54 is shown in the actuation device 38 through which an end 56 of the rod 36 can be seen. The raceway 54 includes a first end 58 and a second end 60 that delimit the movement of a pin or bolt 62 that extends through the rod 36 to thereby restrict its movement relative to the raceway 54. In the neutral position E shown in FIG. 4, the pin 62 is between the first end 58 and the second end 60. But if a straight pulling force were exerted on the towing apparatus 12, as indicated by double-headed arrow end F, the pin 62 would be pulled into contact with the first end 58, which would stop further travel of the pin 62. Similarly, if a straight pushing force were exerted on the towing apparatus 12, as indicated by double-headed arrow end G, the pin 62 would be pulled into contact with the second end 60, which would halt further travel of the pin 62.

As further shown in FIG. 4 and similar to the foregoing, a window, raceway, or slot 64 is shown in the actuation device 44 through which an end 66 of the rod 42 can be seen. The raceway 64 includes a first end 68 and a second end 70 that delimit the movement of a pin or bolt 72 that extends through the rod 42 to restrict its movement relative to the raceway 64. In the neutral position E shown here, the pin 72 is between the first end 68 and the second end 70. Once again, if a straight pulling force were exerted on the towing apparatus 12, as indicated by double-headed arrow end H, the pin 72 would be pulled into contact with the first end 68, which would stop further travel of the pin 72. Similarly, if a straight pushing force were exerted on the towing apparatus 12, as indicated by double-headed arrow end I, the pin 72 would be pulled into contact with the second end 70, which would stop further travel of the pin 72.

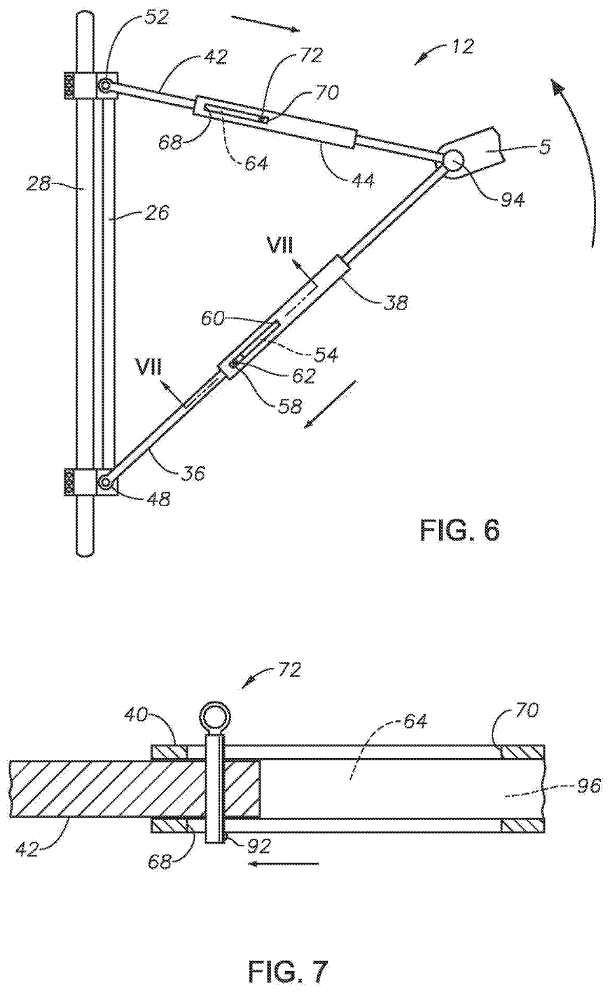

As introduced with respect to FIG. 1 and described above with respect to FIG. 4, those skilled in the art will understand that if a left or right turning force is applied to the towing apparatus 12, the pins 62, 72 will be pulled or pushed towards opposite ends of their actuation devices 38, 44. For instance, and as explained in more detail with reference to FIGS. 6 and 7 below, in a left-hand turn, pin 62 could be pulled against end 58 while pin 72 could be pressed against end 70, but in a right-hand turn, pin 62 could be pressed against end 60 while pin 72 is pulled against end 68.

By way of example, the clamping device 32 introduced above is shown in greater detail in FIG. 5 in which the clamping device 32 is attached with the attachment mechanism 74 to the spreader bar 28. Here, a neoprene insert or wrap 76, which may be any rubber or cushioning material, may be applied between the spreader bar 28 and the clamping device 32 to prevent damage to the spreader bar 28. The clamping device 32 may be at first separated into two parts 32A and 32B in order to place them over and under the spreader bar 28. This may be accomplished using a rotational mechanism such as a swivel bolt 78 that may have a head or body 80 that fits through an aperture 82 in the end 52 of the rod 42. Once the parts 32A and 32B are installed respectively over and under the spreader bar 28, the bolt body 80 can be inserted through the aperture 82 and a nut 84 used to rotationally secure together the parts 32A and 32B to effect installation of the clamping device 32. A similar arrangement would be used at the end 48 of the rod 36 shown in FIG. 4. Thus, the rods 36, 42 can swivel as the towing apparatus 12 is pushed or pulled to the right or left.

FIG. 5 most clearly shows additional details of the actuation device 44, as introduced above in FIG. 4. Here, the pin 72 includes a grip or ring 86 and an end 90 that extends through an aperture 88 in the rod 42. A spring actuated ball lock 92 may be provided at the end 90 to secure the pin 72 through the rod 42, i.e., the ball lock 92 compresses as it is inserted in the aperture 88 and springs open when it emerges from the aperture 88 to lock the pin 72 through the rod 42. As further shown in this example, the ends 68, 70 of the raceway 64 limit travel of the pin 72. And while the rod 42 is permitted to telescope within a channel 96 of the raceway 64, axial movement of the rod 42 is limited by the pin 72 as it engages the ends 68, 70 of the raceway 64, depending on variable pushing, pulling, and directional forces, as indicated by the double-headed arrow. In the neutral position E shown here, the pin 72 is between the first end 68 and the second end 70. Those skilled in the art will understand that certain components can be reversed and are not limited to the examples shown. For instance, the pins 62, 72 described above could be formed with rods 34, 40, and the rods 36, 42 could be fixed such that the rods 34, 40 are made movable with respect to the actuating devices 38, 44. Still further, raceways 54, 64 and associated components can be adapted to tops, sides, or bottoms of their respective actuation devices 38, 44 and are not limited to the examples shown.

In FIG. 6, a left turn, pulling force is shown being exerted on the towing apparatus 12, as indicated by a large, curved arrow. In this example, the towing apparatus 12 is connected to the spreader bar 28 and tractor hitch 5 as described above, and here, the pin 72 of the telescoping device 44 is being pushed into contact with the end 70 of the raceway 64 while the pin 62 of the telescoping device 38 is being pulled into contact with the end 58 of the raceway 54. Here again, the ends 60, 62, 68, 70 delimit the movement of the pins 62,72 that extend through the rods 36, 42 to limit their movement relative to the raceways 54, 64. In the turning state shown in FIG. 6, the rotational ends 48, 52, and rotational connection device 94 cooperate to permit telescoping operation of the actuating devices 38, 44 in respective directions, as indicated by the directional arrows.

FIG. 7 shows a right turn, pulling force being exerted in which an axial movement of the rod 42, indicated by the arrow, is limited by the pin 72 as it starts to engage the end 68 within the channel 96 of the raceway 64. As above, the ball lock 92 locks the pin 72 through the rod 42 to retain the end 68 of the rod 42 in the channel 96 of the raceway 64. Those skilled in the art will appreciate that the lock 92 is not limited to a spring-loaded ball but could be another detent mechanism, a Cotter key, or the like.

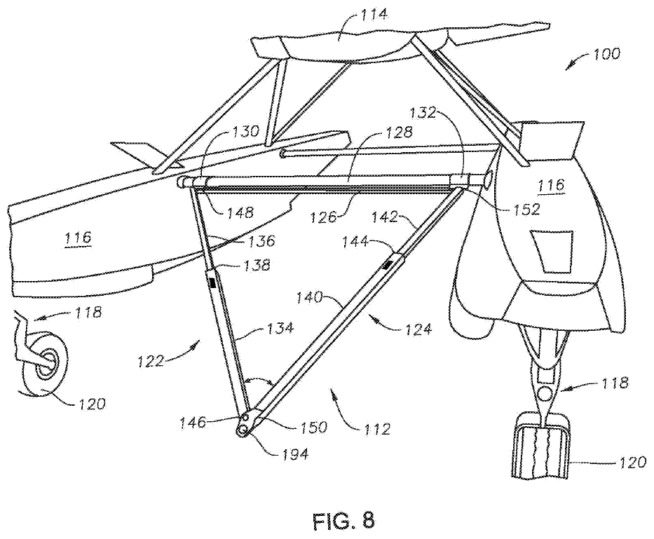

Turning to FIG. 8, an exemplary towing system 110 is broadly shown to include a towing apparatus 112 with a responsive bar 122, a second responsive bar 124, and a fixed bar 126. The towing apparatus 112 in this example is connected to a spreader bar 128 of a seaplane 114 using clamping devices 130, 132. The responsive bar 122 includes a rod 134 that receives a smaller rod 136; however, sizes may be reversed such that rod 136 could be larger to receive the rod 134. Similarly, the responsive bar 124 may include a rod 140 that receives another rod 142. As shown, the responsive bar 122 may be rotationally formed at one end 146 and rotationally connected at an opposite end 148 to the clamping device 130. And the responsive bar 124 may be rotationally connected at one end 150 and rotationally connected at an opposite end 152 to the clamping device 132. This arrangement will apply towing and other forces to the towing apparatus 112 rather to landing gear 118. More particularly, a scissor-like attachment assembly 194, which may include an aperture or ring, is provided for connecting the ends 146, 150 to a tug (such as tractor 3 shown in FIG. 2). In operation, as the plane 114 and the towing apparatus 112 are turned, the scissor-like attachment assembly 194 will permit the bars 122, 124 to scissor towards each other, as indicated by the double-headed arrow between the bars 122, 124. The attachment mechanism 194 is not limited to the example shown and may include a hook, a chain, a cap, and the like.

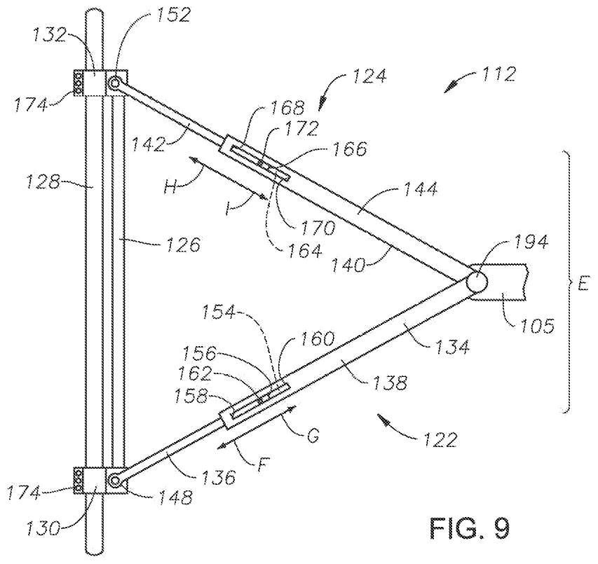

FIG. 9 more particularly shows the towing apparatus 112 and its bars 122, 124, 126, respective rods 134, 136, 140, 142, and actuation mechanisms 138, 144 in a neutral position E, as introduced in FIG. 8. The clamping devices 130, 132 may include attachment devices 174 such as bolts, screws, Cotter keys or the like to connect the towing apparatus 112 to the cross bar 128 as described above. More specifically, a window, raceway, or slot 154 is shown in the actuation mechanism 138 through which an end 156 of the rod 136 can be seen. The raceway 154 includes a first end 158 and a second end 160 that delimit the movement of a pin or bolt 162 that extends through the rod 136 to thereby restrict its movement relative to the raceway 154. As shown in this neutral position E, the pin 162 is between the first end 158 and the second end 160. But if a straight pulling force were exerted on the towing apparatus 112, as indicated by double-headed arrow end F, the pin 162 would be pulled into contact with the first end 158, which would stop further travel of the pin 162. Similarly, if a straight pushing force were exerted on the towing apparatus 112, as indicated by double-headed arrow end G, the pin 162 would be pulled into contact with the second end 160, which would halt further travel of the pin 162.

As further shown in FIG. 9 and similar to the foregoing, a window, raceway, or slot 164 is shown in the actuation mechanism 144 through which an end 166 of the rod 142 can be seen. The raceway 164 includes a first end 168 and a second end 170 that delimit the movement of a pin or bolt 172 that extends through the rod 142 to restrict its movement relative to the raceway 164. Here again, in the neutral position E, the pin 172 is between the first end 168 and the second end 170. So, if a straight pulling force were exerted on the towing apparatus 112, as indicated by double-headed arrow end H, the pin 172 would be pulled into contact with the first end 168, which would stop further travel of the pin 172. Similarly, if a straight pushing force were exerted on the towing apparatus 112, as indicated by double-headed arrow end I, the pin 172 would be pulled into contact with the second end 170, which would stop further travel of the pin 172. Those skilled in the art will understand that certain components can be reversed and are not limited to the examples shown. For example, raceways 154, 164 and associated components can be adapted to tops, sides, or bottoms of their respective actuation mechanisms 138, 144 and are not limited to the examples shown.

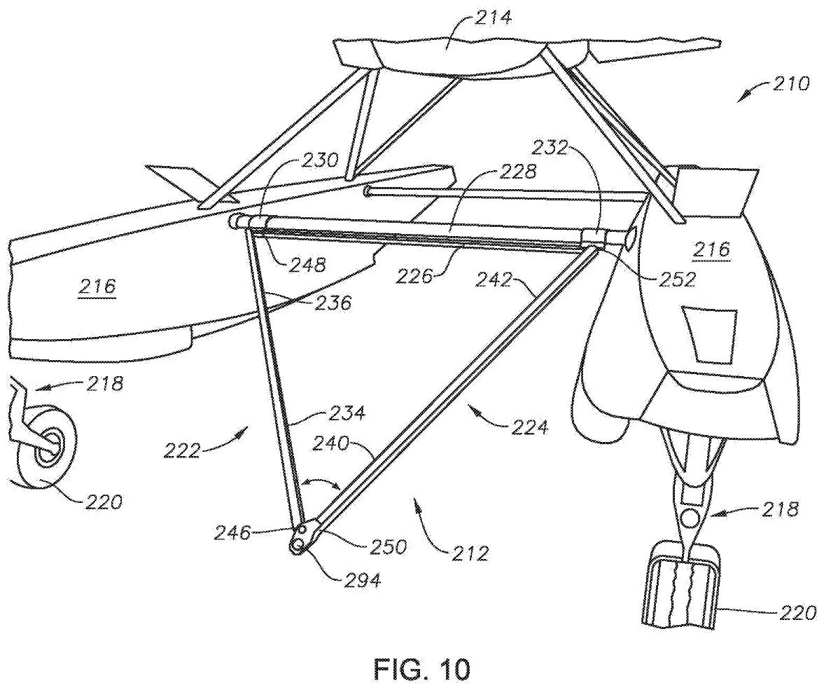

FIG. 10 shows another exemplary towing system 210 with a towing apparatus 212 having a bar 222, a second bar 224, and a cross bar 226. The towing apparatus 212 in this example is connected to a spreader bar 228 of a seaplane 214 using clamping devices 230, 232. The bar 222 in this example includes a first end or half 234 and a second end or half 236. Similarly, the bar 224 may include first end or half 240 and a second end or half 242. As shown, the bar 222 may be rotationally formed at one end 246 and rotationally connected at an opposite end 248 to the clamping device 230. And the bar 224 may be rotationally connected at one end 250 and rotationally connected at an opposite end 252 to the clamping device 232. This arrangement will apply towing and other forces to the towing apparatus 212 rather to landing gear 218. More particularly, a scissor-like attachment assembly 294, which may include an aperture or ring, is provided for connecting the ends 246, 250 to a tug (such as tractor 3 shown in FIG. 2).

Some exemplary embodiments of the present disclosure may include but are not limited to:

### Embodiment 1

An airplane towing system comprising a first telescoping bar having a proximal end and a distal end, the distal end being configured for rotatable connection to a tow hitch, the first telescoping bar being configured to compress or extend in response to an external force; a first actuator disposed between the proximal and distal ends of the first telescoping bar, the first actuator being adapted to compress or extend the first telescoping bar in response to the external force; a second telescoping bar having a proximal end and a distal end, the distal end of the second telescoping bar being configured for rotatable connection to the tow hitch, the second telescoping bar being configured to compress or extend in response to the external force; a second actuator disposed between the proximal and distal ends of the second telescoping bar, the second actuator being adapted to compress or extend the second telescoping bar in response to the external force; a first clamping assembly rotatably connected to the proximal end of the first telescoping bar; and a second clamping assembly rotatably connected to the proximal end of the second telescoping bar, the first and second clamping assemblies being attachable to an airplane.

### Embodiment 2

The airplane towing system as in Embodiment 1, wherein the first telescoping bar includes a proximal rod and a distal rod and wherein the proximal rod is movable within the first actuator.

### Embodiment 3

The airplane towing system as in Embodiments 1 or 2, wherein the second telescoping bar includes a proximal rod and a distal rod and wherein the proximal rod is movable within the second actuator.

### Embodiment 4

The airplane towing system as in any of the foregoing embodiments, wherein the first actuator includes a raceway formed therein and a pin being configured for insertion through the first telescoping bar and through the raceway, the pin and the raceway cooperating to delimit travel of the first telescoping bar.

### Embodiment 5

The airplane towing system as in any of the foregoing embodiments, wherein the second actuator includes a raceway formed therein and a pin being configured for insertion through the second telescoping bar and through the raceway, the pin and the raceway cooperating to delimit travel of the second telescoping bar.

### Embodiment 6

The airplane towing system as in any of the foregoing embodiments, wherein the first and second actuators are configured to cooperate to extend or compress respective first and second telescoping bars in response to the external force.

### Embodiment 7

The airplane towing system as in any of the foregoing embodiments, wherein the external force is selected from the group comprising a towing force, a pushing force, a turning force, and combinations thereof.

### Embodiment 8

The airplane towing system as in any of the foregoing embodiments, further comprising a protective material for placement between the first and second clamping assemblies and a cross beam of the airplane.

### Embodiment 9

The airplane towing system as in any of the foregoing embodiments, further comprising a cross bar connected to the proximal end of the first telescoping bar and the proximal end of the second telescoping bar, the first and second clamping assemblies being attached to the bar.

### Embodiment 10

An airplane towing system, comprising a first telescoping bar having a proximal end and a distal end, the distal end being configured for rotatable connection to a tow hitch, the proximal end being configured to compress or extend relative to the distal end in response to an external force; a second telescoping bar having a proximal end and a distal end, the distal end of the second telescoping bar being configured for rotatable connection to the tow hitch, the proximal end of the second telescoping bar being configured to compress or extend relative to the distal end of the second telescoping bar in response to an external force; a first clamping assembly rotatably connected to the proximal end of the first telescoping bar; and a second clamping assembly rotatably connected to the proximal end of the second telescoping bar, the first and second clamping assemblies being attachable to an airplane.

### Embodiment 11

The airplane towing system as in Embodiment 10, further comprising a protective material for placement between the first and second clamping assemblies and a cross beam of the airplane.

### Embodiment 12

The airplane towing system as in Embodiments 10 or 11, further comprising a cross bar connected to the proximal end of the first telescoping bar and the proximal end of the second telescoping bar.

### Embodiment 13

An airplane towing system, comprising a first bar having a proximal end and a distal end, the distal end being configured for rotatable connection to a tow hitch; a second bar having a proximal end and a distal end, the distal end of the second bar being configured for rotatable connection to the tow hitch; a first clamping assembly rotatably connected to the proximal end of the first telescoping bar; a second clamping assembly rotatably connected to the proximal end of the second bar; and a protective material configured for placement between the first and second clamping assemblies and a cross beam of the airplane, the first and second clamping assemblies being attachable the cross-beam airplane.

### Embodiment 14

The airplane towing system as in Embodiment 13, further comprising a cross bar connected to the proximal end of the first bar and the proximal end of the second bar.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

That which is claimed is:

1. An airplane towing system, comprising:
a first telescoping bar having a proximal end and a distal end, the distal end being configured for rotatable connection to a tow hitch, the first telescoping bar being configured to compress or extend in response to an external force;
a first actuator disposed between the proximal and distal ends of the first telescoping bar, the first actuator being adapted to compress or extend the first telescoping bar in response to the external force;
a second telescoping bar having a proximal end and a distal end, the distal end of the second telescoping bar being configured for rotatable connection to the tow hitch, the second telescoping bar being configured to compress or extend in response to the external force;
a second actuator disposed between the proximal and distal ends of the second telescoping bar, the second actuator being adapted to compress or extend the second telescoping bar in response to the external force;
a first clamping assembly rotatably connected to the proximal end of the first telescoping bar; and
a second clamping assembly rotatably connected to the proximal end of the second telescoping bar, the first and second clamping assemblies being attachable to an airplane.

2. The airplane towing system as in claim 1, wherein the first telescoping bar includes a proximal rod and a distal rod and wherein the proximal rod is movable within the first actuator.

3. The airplane towing system as in claim 1, wherein the second telescoping bar includes a proximal rod and a distal rod and wherein the proximal rod is movable within the second actuator.

4. The airplane towing system as in claim 1, wherein the first actuator includes a raceway formed therein and a pin being configured for insertion through the first telescoping bar and through the raceway, the pin and the raceway cooperating to delimit travel of the first telescoping bar.

5. The airplane towing system as in claim 1, wherein the second actuator includes a raceway formed therein and a pin being configured for insertion through the second telescoping bar and through the raceway, the pin and the raceway cooperating to delimit travel of the second telescoping bar.

6. The airplane towing system as in claim 1, wherein the first and second actuators are configured to cooperate to extend or compress respective first and second telescoping bars in response to the external force.

7. The airplane towing system as in claim 1, wherein the external force is selected from the group comprising a towing force, a pushing force, a turning force, and combinations thereof.

8. The airplane towing system as in claim 1, further comprising a protective material for placement between the first and second clamping assemblies and a cross-beam of the airplane.

9. The airplane towing system as in claim 1, further comprising a cross bar connected to the proximal end of the first telescoping bar and the proximal end of the second telescoping bar.

10. An airplane towing system, comprising:
a first telescoping bar having a proximal end and a distal end, the distal end being configured for rotatable connection to a tow hitch, the proximal end being configured to compress or extend relative to the distal end in response to an external force;
a second telescoping bar having a proximal end and a distal end, the distal end of the second telescoping bar being configured for rotatable connection to the tow hitch, the proximal end of the second telescoping bar being configured to compress or extend relative to the distal end of the second telescoping bar in response to an external force;
a first clamping assembly rotatably connected to the proximal end of the first telescoping bar; and
a second clamping assembly rotatably connected to the proximal end of the second telescoping bar, the first and second clamping assemblies being attachable to an airplane.

11. The airplane towing system as in claim 10, further comprising a protective material for placement between the first and second clamping assemblies and a cross beam of the airplane.

12. The airplane towing system as in claim 10, further comprising a cross bar connected to the proximal end of the first telescoping bar and the proximal end of the second telescoping bar.

13. An airplane towing system, comprising:
a first bar having a proximal end and a distal end, the distal end being configured for rotatable connection to a tow hitch;
a second bar having a proximal end and a distal end, the distal end of the second bar being configured for rotatable connection to the tow hitch;
a first clamping assembly rotatably connected to the proximal end of the first telescoping bar;
a second clamping assembly rotatably connected to the proximal end of the second bar; and
a protective material configured for placement between the first and second clamping assemblies and a cross beam of the airplane, the first and second clamping assemblies being attachable the cross-beam airplane.

14. The airplane towing system as in claim 13, further comprising a cross bar connected to the proximal end of the first bar and the proximal end of the second bar.
